(19) United States
(12) Patent Application Publication
(10) Pub. No.: US 2020/0151283 A1
(43) Pub. Date: May 14, 2020

(54) LOCATION PLAN OPTIMIZATION

(71) Applicant: SAP SE, Walldorf (DE)

(72) Inventor: Tobias Haag, Wiesloch (DE)

(21) Appl. No.: 16/191,332

(22) Filed: Nov. 14, 2018

(51) Int. Cl. G06F 17/50; G06Q 10/10

(52) U.S. Cl. CPC G06F 17/50; G06Q 10/105

(57) ABSTRACT

In one embodiment, a method receives input specifying criteria for generating a seating plan where at least a portion of the criteria includes a priority value. A layout of locations is received in which the seating plan is applied and a valuation function is received that defines a scoring system for the plan. The scoring system using the priority value to generate a score for criteria associated with the priority value. The method creates a set of seating plans based on the criteria to place users in locations in the layout. The set of seating plans include different combinations of users placed in different locations. A seating plan is selected that maximizes a result from scores generated for criteria in the seating plan over other results associated with other seating plans. Then, the method outputs the seating plan.

### BACKGROUND

The seating plan may be an important aspect of office planning for a company. The seating plan may be generated when a company moves to a new office building, but also many generated times while the company is in a current office building when departments move to different locations or anytime when users are reassigned seating. Typically, a manager may create the seating plan manually. The manager may consider some factors when creating the seating plan, such as if there are people on a team who should sit next to each other because of their roles (e.g., it might make sense to allocate all the software architects next to each other). Another consideration is some people may work better together than others because of certain reasons, such as personal preference. Also, some desks may be different, such as some desks might be next to a window. Balancing all these factors makes the allocation of the desks to each employee a time-consuming and complicated task for a manager.

### BRIEF DESCRIPTION OF THE DRAWINGS

FIG. 1 depicts a simplified system for generating a seating plan according to some embodiments.

FIG. 2 depicts a simplified flowchart of a method for receiving criteria for the seating plan according to some embodiments.

FIG. 3 depicts a simplified flowchart of a method for generating a seating plan according to some embodiments.

FIG. 4A shows an example of an office layout according to some embodiments.

FIG. 4B shows an example of the office layout in table format, which could be received in a format according to some embodiments.

FIG. 5 depicts an example of a table describing criteria received from a first user with a first type of role according to some embodiments.

FIG. 6 depicts an example of criteria provided by a second type of user according to some embodiments.

FIG. 7 depicts an example of a seating plan that is selected according to some embodiments.

FIG. 8 shows a visualization of the seating assignment with the names of the users inserted into the assigned desks according to some embodiments.

FIG. 9 depicts an example of using the selected seating plan according to some embodiments.

FIG. 10 illustrates hardware of a special purpose computing machine configured with a seating plan generation system according to one embodiment.

### DETAILED DESCRIPTION

Described herein are techniques for an optimization system. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

Some embodiments generate an optimized seating plan while considering criteria that is input from different users, such as a manager and team members. The seating plan generation system may perform the optimization using management human resources (HR) system that allows the users to define the criteria. For example, the seating plan generation system may receive a layout of available desks that should be assigned to users. Then, an HR system may contact the users and request input for the criteria. The HR system may provide different users different interfaces depending on the type of user, such as a manager may receive a different interface and be allowed to input different criteria than other employees, such as team members. Then, the seating plan generation system generates an optimized seating plan.

In some embodiments, the optimized seating plan may use a priority that is assigned to some criteria. In some embodiments, a manager is allowed to input a priority for different criteria, such as a user #1 may be seated next to a user #2, and that criterion is assigned a certain priority. The seating plan generation system optimizes the seating plan using the priority. The use of the priority improves the generation of the seating plan because instead of attempting to satisfy the most criteria, the seating plan generation system attempts to find the best solution based on the priority. This may optimize the seating plan and provide users with desk locations that better fit the preferences provided in the criteria rather than attempting to fulfill the most criteria.

Once the seating plan is generated, the HR system may notify the various users with desk identifiers that indicate their desk locations. Also, this desk identifier may be automatically written to the employment information used by the company for different users.

### System Overview

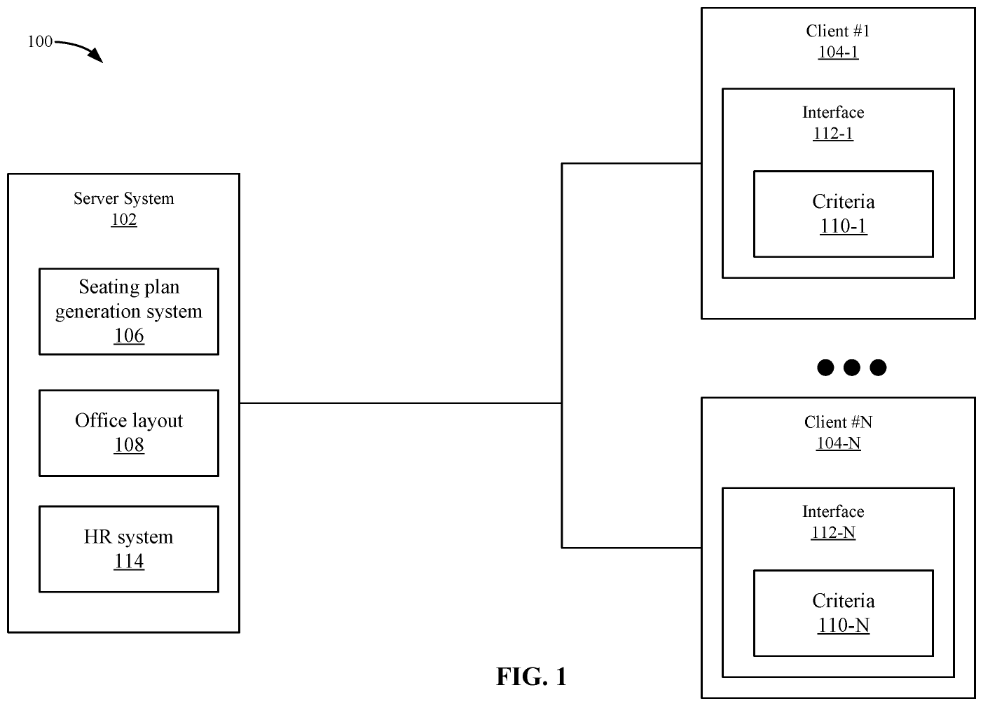

FIG. 1 depicts a simplified system 100 for performing seating plan generation according to some embodiments. System 100 includes a server system 102 and clients 104-1 to 104-N. Server system 102 may include one or more computers that may generate a seating plan and also communicate with clients 104, which may be computers that are used by users.

A seating plan generation system 106 may generate a seating plan for users of a company. The seating plan may allocate desks to users. Although desks are described, the seating plans may allocate locations in the office building that are assigned to users. For example, the seating plan generation system may be used to assign cubicles, auditorium seats, and other seating arrangements. Accordingly, in some examples, users may be assigned locations instead of desks.

An office layout 108 may define the layout of desks in an office building for the company. The layout may indicate the relationship among desks, such as which desks are neighbors, which desks are located next to other objects, such as windows, etc. Users may input criteria that define preferences in the seating plan. Criteria may include a base user, a target, an operation, and a priority. The base user may be the object of the criteria, an operation specifies a comparator that compares the seating of the base user to the target user, such as “next to”, “not next to”, or other comparators. The target user is another user that the operation operates on, such as the base user is compared to the target user using the operation. A priority may indicate the priority of the criteria. For example, the criterion of John being next to Alice may be rated on a priority scale from 1 to 10. Additionally, a priority may also be mandatory where the criteria should be always honored.

In some examples, clients #1 to #N 104-1 to 104-N may include user interfaces 112-1 to 112-N that users use to input criteria 110-1 to 110-N. Some examples of criteria may be specifying that a user would be next to another user or specifying a priority for the criteria.

Once seating plan generation system 106 receives the criteria from the users, seating plan generation system 106 uses the criteria and office layout 108 to generate a seating plan. As will be discussed in more detail below, seating plan generation system 106 may analyze the criteria and generate an optimized seating plan based on office layout 108. The seating plan generation process will be described in more detail below.

An HR system 114 may then use the seating plan to generate a report that may indicate which criteria were satisfied and not satisfied in the seating plan. For example, the report may indicate to a manager that some criteria, such as a user not being seated next to another user, was not fulfilled by the seating plan. HR system 114 may also add the location identifiers in a field for employment information for the users.

### Criteria Generation

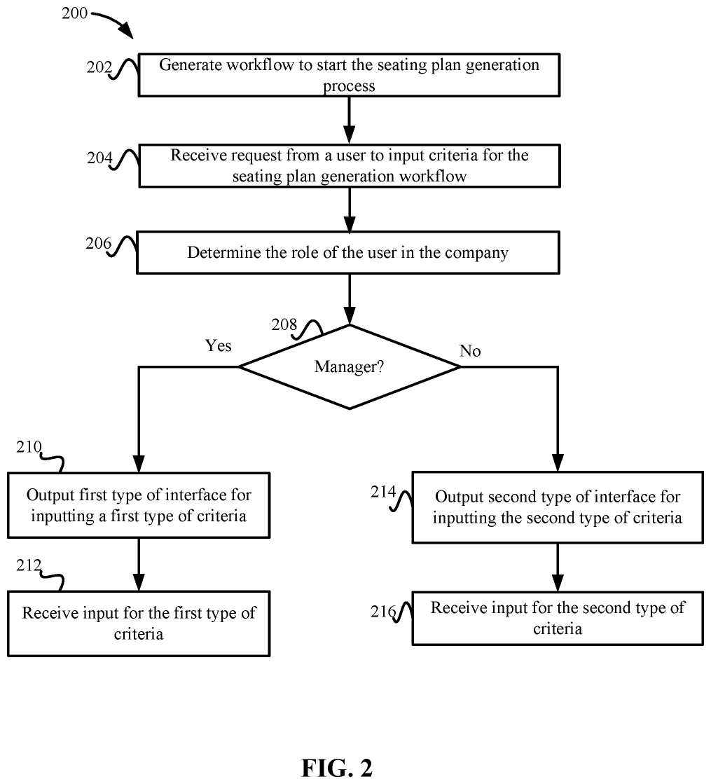

FIG. 2 depicts a simplified flowchart 200 of a method for receiving criteria for seating plan generation according to some embodiments. At 202, HR system 114 may generate a workflow to start the seating plan generation process. For example, a company may have software that may manage certain aspects of the business for the company, such as human resources software. The workflow may be generated when a seating plan needs to be generated.

At 204, seating plan generation system 106 may receive a request from a user to input criteria for the desk allocation workflow. For example, HR system 114 may send alerts to users to participate in the desk allocation process and input criteria.

The users may be employees of the company where employees may be assigned different roles in the company, such as a manager role or team member role. The roles may have different priorities, such as one user may have a first priority (e.g., a manager may have a manager's priority), and other members of the manager's team may have another type of priority (e.g., a team member's priority). The manager's priority and the team member priority may allow users access to different features of the system. For example, the manager's priority may allow a manager to input different criteria from the team member's priority. Also, the priority may restrict viewing access to criteria that is input, such as a manager may view other team members' criteria, but team members cannot view other team members' criteria or the manager's criteria. At 206, seating plan generation system 106 thus determines the role of the user in the company, such as whether the user is a manager, team member, or any other hierarchical information that is used by the company to classify the roles of users.

At 208, seating plan generation system 106 determines if the role of the user is a manager. Although a manager is discussed, other roles may be appreciated. For example, the roles may be organized in a hierarchical structure and the manager may be at one level of the hierarchy.

At 210, if the role is associated with a manager, seating plan generation system 106 outputs the first type of interface for inputting a first type of criteria. For example, only users with a role of manager may be able to input the first type of criteria. As will be explained in more detail below, a manager may be able to input criteria for users other than the manager, such as for users that are part of the team that the manager manages. Also, the manager may be able to input different information for criteria, such as a priority for some of the criteria may be available only to managers. For example, the manager may be able to insert the priority for various criteria, such as positioning Alice next to John is given a high priority. At 212, seating plan generation system 106 receives input for the first type of criteria.

If the user does not have the role of a manager, at 214, seating plan generation system 106 outputs a second type of interface for inputting a second type of criteria. The second type of criteria may not include the ability to input criteria for other users. For example, the user John may only be able to input criteria defining who Alice would like to sit next to. Also, John may not be able to input a priority. However, in other embodiments, John may be able to input a priority. Also, the second type of interface may not allow the user to view criteria input by the manager or other users. At 216, seating plan generation system 106 receives input for the second type of criteria.

### Seating Plan Generation Process

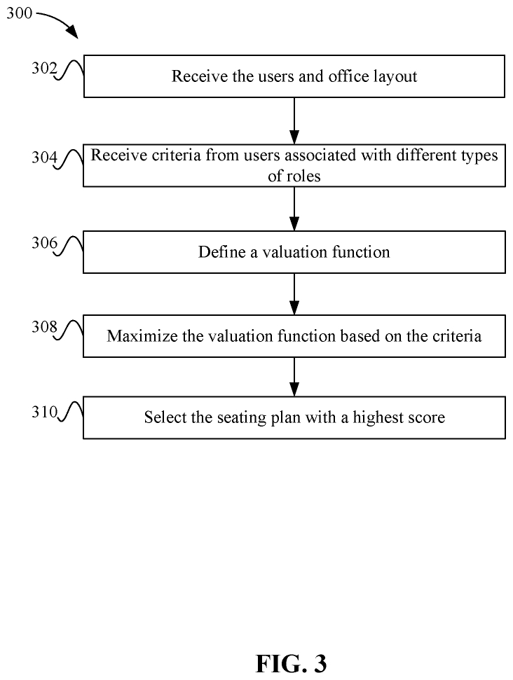

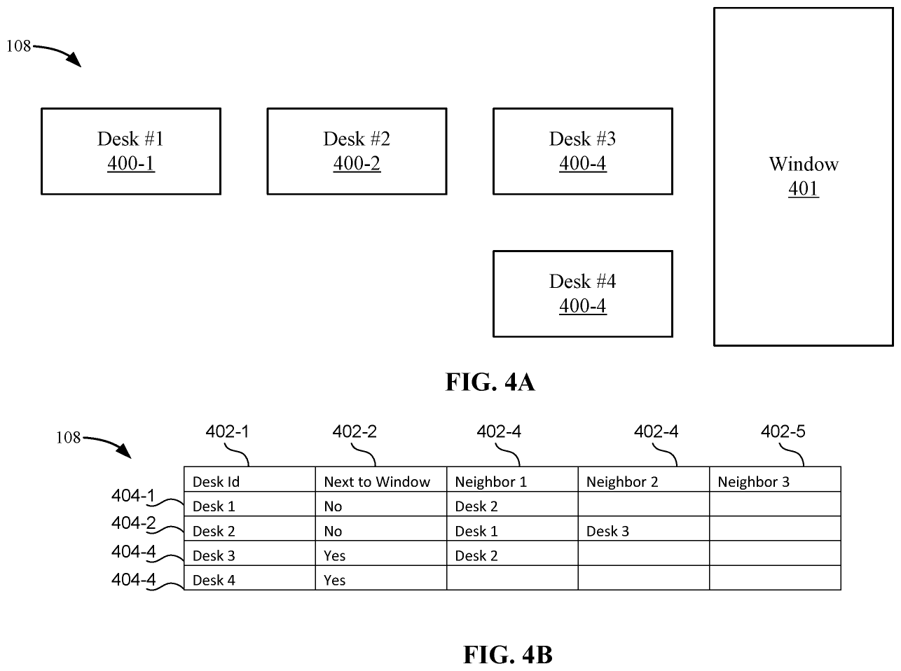

Once receiving the criteria, seating plan generation system 106 can generate an optimized seating plan. FIG. 3 depicts a simplified flowchart of a method for generating a seating plan according to some embodiments. At 302, seating plan generation system 106 receives the users and the office layout 108. The users may be the employees that are eligible to be allocated desks in the seating plan. The office layout may specify the desk layout in which users will be assigned seats. FIG. 4A shows an example of office layout 108 according to some embodiments. Office layout 108 includes four desks, #1 to #4 400-1 to 400-4. These desks may be arranged with respect to one another. For example, desks may be arranged as side-by-side neighbors, such as desk #1 is a neighbor to desk #2; desk #2 is a neighbor to desk #3; desk #3 is a neighbor to a window 401; and desk #4 is a neighbor to window 401. The desks may also be arranged in a forward or backward relationship although the following examples may not take forward and backward neighbors into account. For example, desk #3 is in front of desk #4. Diagonal neighbors may also be used, such as desk #2 may be a diagonal neighbor to desk #4, but diagonal neighbors are not considered in this example. Although the neighbor criterion is used, other criteria may also be possible. For example, desks may be assigned as inner desks and window desks, cubicles, enclosed offices, etc.

FIG. 4B shows an example of office layout 108 in table format, which could be received in a format, such as a .csv file, according to some embodiments. The table summarizes the definition of available desks and the relationship between the desks. Columns 402-1 to 402-5 show a desk identifier (ID) column, a next-to-window column, a neighbor 1 column, a neighbor 2 column, and a neighbor 3 column. The desk ID column lists the ID of the desk, such as desk #1, desk #2, desk #3, and desk #4 in rows 404-1 to 404-4. For each desk identified, office layout 108 indicates whether the desk is next to a window, whether the desk has a neighbor 1, a neighbor 2, and a neighbor 3. Neighbor 1 may be the neighbor to the left or right. In this example, only neighbor 1 and neighbor 2 are used because no desk has 3 neighbors because the forward, the backward, and the diagonal neighbors are not taken into account.

In the layout, desk #1 is not next to a window 401 and is next to desk #2 only. Desk #2 is not next to window 401, but next to desk #1 and desk #3. Desk #3 is next to window 401 and also next to desk #2. Forward and backward neighbors are not taken into account in this example, but desk #4 may be a neighbor to desk #3 if the forward neighbor or the backward neighbor is taken into account. Finally, desk #4 is only next to window 401.

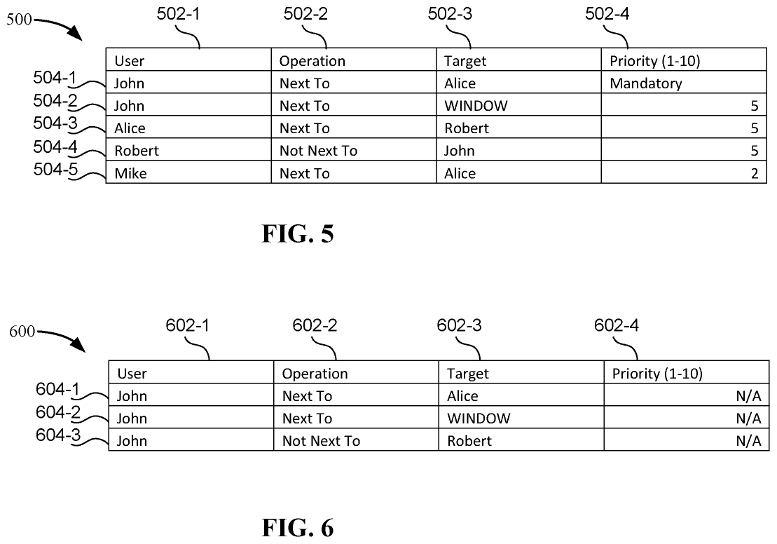

At 304, seating plan generation system 106 receives criteria from users associated with different types of roles. For example, seating plan generation system 106 may receive criteria from a manager and also from team members. FIG. 5 depicts an example of a table 500 describing criteria received from a first user with a first type of role according to some embodiments. In some examples, table 500 summarizes the criteria received from a manager. The manager can enter mandatory and optional criteria. In some examples, the optional criteria may be a priority. Also, the mandatory criteria may be a base user, an operation, and a target user. As discussed above, the manager may be provided a special interface 112-1 for the manager's role to input the criteria.

Table 500 includes columns 502-1 to 502-4 that summarize information received from the manager to specify a base user, an operation, a target user, and a priority. The base user may specify a user that is associated with the operation. The operation may be an operator that specifies some type of relationship, such as next to or not next to. The target user may be the object of the operation. The priority may be the priority that is assigned to the criteria. In some examples, the priority may be from a range, such as from 1 to 10. An additional priority may be “mandatory”, which means that this criteria needs to be satisfied in the seating plan. Other types of priority systems may be used also.

In table 500, in row 504-1, a criterion specifies that a user, John, should be next to Alice with a priority of mandatory. Also, a second criterion in row 504-2 indicates that John should be next to a window with a priority of 5. Other criteria in rows 504-3 to 504-5 indicate that Alice should be next to Robert with a priority of 5, Robert should not be next to John with a priority of 5, and Mike should be next to Alice with a priority of 2. Accordingly, the operations indicate which users should be next to each other and which users should not be next to each other. Further, the target user may be a user or other object, such as window 401. Although the above operations and targets are used, other operations may be used and other targets may be used. For example, an operation may be “assigned to” and the target may be a window office.

FIG. 6 depicts an example of criteria provided by a second type of user according to some embodiments. Table 600 may summarize criteria from a user that is not a manager, such as a team member. Table 600 includes similar columns 602-1 to 602-4 as shown in FIG. 5. However, column 602-4 for inputting a priority may not be available for input. However, in other embodiments, the team member may input a priority. Also, the team member may only input criteria for himself or herself as the base user, and not for any other users as the base user.

As summarized in table 600, a user, John, has input three criteria. Row 604-1 indicates that the user, John, should be next to Alice. Also, row 604-2 indicates the user, John, should be next to window 401. Finally, row 604-3 indicates that user, John, should not be next to Robert. These criteria are all requested to be fulfilled by John. However, logic may be applied in that the user may request a first criterion and if that criterion is not fulfilled, a second criterion is specified, etc. Other logic may also be applied to specify criteria for both managers and team members.

Referring back to FIG. 3, seating plan generation system 106 defines a valuation function. The valuation function may define how to quantify a complete seating plan. The valuation function takes a complete seating plan as input and evaluates it based on the given criteria. For example, the valuation function may indicate the priority assigned to a criterion that is fulfilled is added to a result, the priority assigned to a criterion that is not fulfilled is subtracted from a result. For a mandatory priority, a large value may be used as a priority because this will distinguish the seating plans that satisfy the mandatory criteria and make it more likely that a seating plan that satisfies the mandatory criteria is selected. If no priority was used in a criterion it may be treated as a priority of “1”, which is the lowest priority possible. Although this valuation function is described other valuation functions may be described.

At 308, seating plan generation system 106 maximizes the valuation function based on the criteria. Seating plan generation system 106 may perform the maximization using an optimization process. By maximizing the valuation function, seating plan generation system 106 may select the solution that has the highest valuation based on the valuation function. This ensures that the seating plan generation system 106 intelligently assigns seats to users based on the criteria received. The optimization process may try different combinations and seating plan generation system 106 selects the combination with the highest result. In some embodiments, seating plan generation system 106 may not try all possible combinations because the number of combinations becomes too large when a number of desks is more than just a few desks. By intelligently determining the combinations, seating plan generation system 106 more efficiently determines the solution. Thus, the use of the priority improves the process of selecting a seating plan.

In some examples, seating plan generation system 106 may first randomly generate a seating plan and evaluate the seating plan based on the valuation function. Then, seating plan generation system 106 may refine the seating plan and evaluate the new seating plan. The refinement may continue as seating plan generation system 106 tries different seating plans. The priority may be used to guide seating plan generation system 106 in which refinements are made. For example, seating plan generation system 106 may not make a seating plan change that makes a mandatory criterion be not fulfilled.

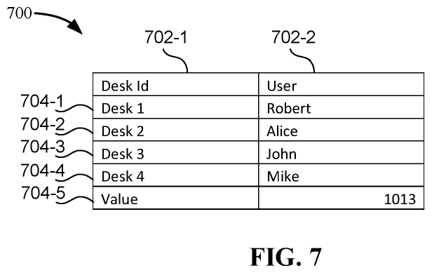

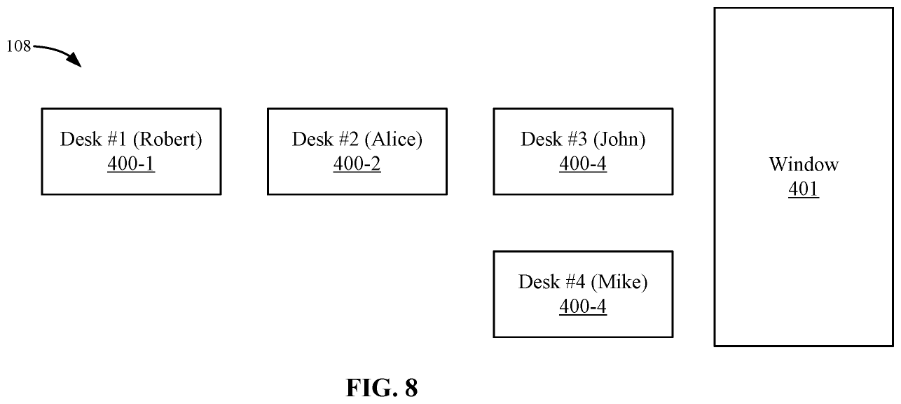

Referring back to FIG. 3, at 310, seating plan generation system 106 may select the seating plan with the highest result. FIG. 7 depicts an example of a seating plan that is selected according to some embodiments. Table 700 includes a column 702-1 for the desk ID and a column 702-2 that assigns a user to the desk ID. Rows 704-1 to 704-4 assign users to desks #1 to #4 and row 704-5 summarizes the value for the seating plan. In this example, Robert has been assigned to desk #1, Alice has been assigned to desk #2, John has been assigned to desk #3, and Mike has been assigned to desk #4. FIG. 8 shows a visualization of the seating assignment with the names of the users inserted into the assigned desks according to some embodiments.

When evaluating the seating plan, seating plan generation system 106 may evaluate the criteria found in FIG. 5 to determine the value for the seating plan. When a criterion is satisfied, seating plan generation system 106 adds the priority to the result, and when a criterion is not satisfied, seating plan generation system 106 subtracts the priority from the result. For example, for the criterion of John next to Alice, seating plan generation system 106 determines that this criterion is satisfied because John is a neighbor to Alice. For a mandatory priority, a large value may be used because this will distinguish the seating plans that satisfy the mandatory criteria. Seating plan generation system 106 may add a value, such as 1000, to the result. Then, the second criterion of John next to window is also true and seating plan generation system 106 adds the priority value of “5” to the result. The third criterion of Alice next to Robert is also true and seating plan generation system 106 adds the priority value of “5” to the result. A fourth criterion of Robert not next to John is also true and seating plan generation system 106 adds the priority value of “5” to the result. However, the fifth criterion of Mike next to Alice is not true as Mike is not to the left or right of Alice. Seating plan generation system 106 subtracts the priority value of “2” from the result. Seating plan generation system 106 gets the final result of 1000+5+5+5−2=1013. Although the above scoring system is described, it will be understood that other systems may be used.

The use of the high mandatory value may remove solutions that do not satisfy the mandatory criteria because seating plan generation system 106 would subtract 1000 from the result. Accordingly, a seating plan that did not fulfill the mandatory criteria most likely would not have the highest result. However, if no solution can be found that fulfills all the mandatory criteria, seating plan generation system 106 may output an error message or warning message indicating that the selected seating plan may not satisfy all the mandatory criteria or no seating plan may be output.

### Result Output

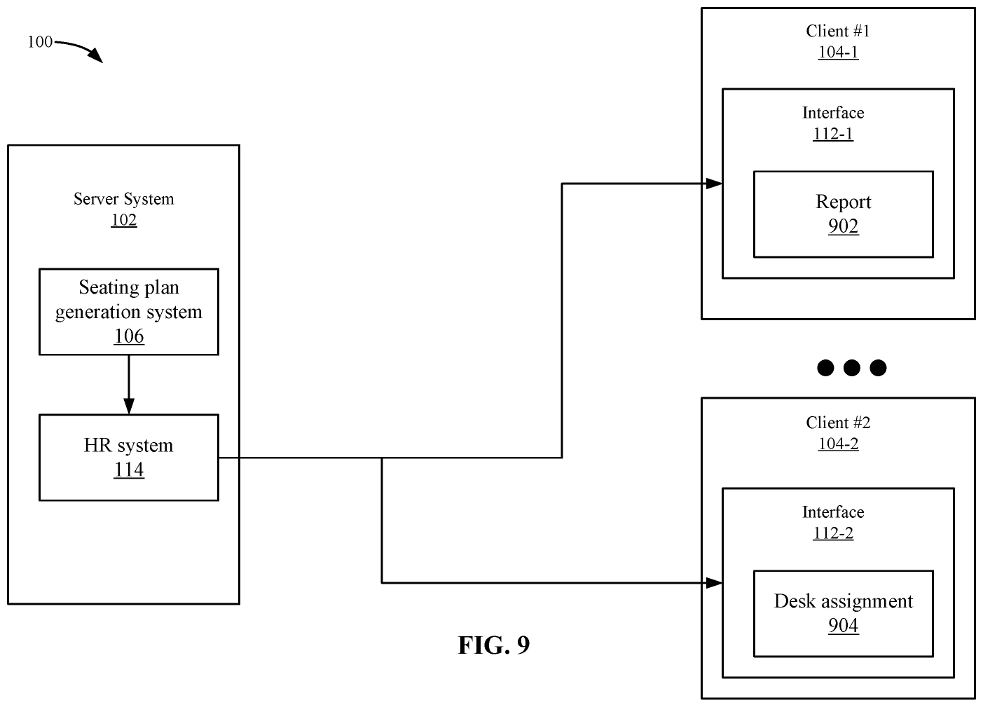

HR system 114 may use the result in managing employment information for the company. FIG. 9 depicts an example of using the selected seating plan according to some embodiments. Seating plan generation system 106 may provide the result of the selected seating plan to HR system 114. The result may be the information provided in table 700 in FIG. 7, which assigns desk IDs to users. HR system 114 may then perform different actions. For example, HR system 114 may review the criteria for the users and generate a report indicating which criteria of the seating plan are fulfilled and which criteria of the seating plan are not fulfilled. In some embodiments, only a manager receives a report. For example, HR system 114 sends a report 902 to a manager using client 104-1. The manager may use interface 112-1 to review report 902.

Also, HR system 114 may input the desk ID in a field used by software to manage the employees. For example, the new desk ID may be input into a field in software that stores employment information for users. Also, HR system 114 may send a desk assignment 904 automatically to users. The users may view the desk assignment, such as a user using client 104-2 may use interface 112-2 to view a desk assignment 904. This user may not be able to review the report, however, because the user is not a manager.

### Conclusion

Accordingly, some embodiments generate a seating plan that is optimized based on priority assigned to criteria. For example, instead of attempting to fulfill the most criteria, seating plan generation system 106 attempts to fulfill the most criteria that are rated the highest. This may create an optimal seating plan. Compared to a manual assignment of seats to employees this approach yields better solutions because a human is usually not able to find a good solution if many desks are involved. Another benefit is that the approach is completely objective and does not favor any employees (except if a criterion was inserted with a mandatory or high priority for that employee)

### System

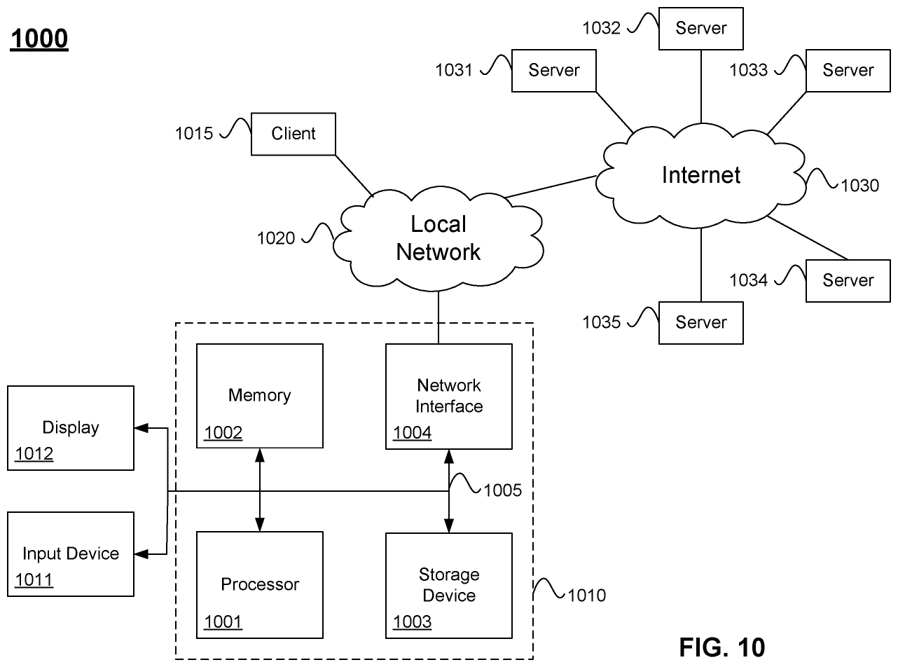

FIG. 10 illustrates hardware of a special purpose computing machine configured with seating plan generation system 106 according to one embodiment. An example computer system 1010 is illustrated in FIG. 10. Computer system 1010 includes a bus 1005 or other communication mechanism for communicating information, and a processor 1001 coupled with bus 1005 for processing information. Computer system 1010 also includes a memory 1002 coupled to bus 1005 for storing information and instructions to be executed by processor 1001, including information and instructions for performing the techniques described above, for example. This memory may also be used for storing variables or other intermediate information during execution of instructions to be executed by processor 1001. Possible implementations of this memory may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1003 may include source code, binary code, or software files for performing the techniques above, for example. Storage device and memory are both examples of computer readable storage mediums.

Computer system 1010 may be coupled via bus 1005 to a display 1012, such as a cathode ray tube (CRT) or liquid crystal display (LCD), for displaying information to a computer user. An input device 1011 such as a keyboard and/or mouse is coupled to bus 1005 for communicating information and command selections from the user to processor 1001. The combination of these components allows the user to communicate with the system. In some systems, bus 1005 may be divided into multiple specialized buses.

Computer system 1010 also includes a network interface 1004 coupled with bus 1005. Network interface 1004 may provide two-way data communication between computer system 1010 and the local network 1020. The network interface 1004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1004 sends and receives electrical, electromagnetic, or optical signals that carry digital data streams representing various types of information.

Computer system 1010 can send and receive information through the network interface 1004 across a local network 1020, an Intranet, or the Internet 1030. In the Internet example, software components or services may reside on multiple different computer systems 1010 or servers 1031-1035 across the network. The processes described above may be implemented on one or more servers, for example. A server 1031 may transmit actions or messages from one component, through Internet 1030, local network 1020, and network interface 1004 to a component on computer system 1010. The software components and processes described above may be implemented on any computer system and send and/or receive information across a network, for example.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, input specifying criteria for generating a seating plan, wherein at least a portion of the criteria includes a priority value;
receiving, by the computing device, a layout of locations in which the seating plan is applied;
receiving, by the computing device, a valuation function that defines a scoring system for the plan, the scoring system using the priority value to generate a score for criteria associated with the priority value;
creating, by the computing device, a set of seating plans based on the criteria to place users in locations in the layout, wherein the set of seating plans include different combinations of users placed in different locations;
selecting, by the computing device, a seating plan that maximizes a result from scores generated for criteria in the seating plan over other results associated with other seating plans; and
outputting, by the computing device, the seating plan.

2. The method of claim 1, wherein selecting the seating plan comprises:
evaluating a criterion in the criteria based on a seating plan in the set of seating plans;
generating a score for the criterion based on the valuation function and the evaluating.

3. The method of claim 2, wherein generating the score for the criterion comprises:
when the criterion is fulfilled by the seating plan, generating a first score using the valuation function; and
when the criterion is not fulfilled by the seating plan, generating a second score using the valuation function.

4. The method of claim 3, wherein:
the first score increases the result for the seating plan, and
the second score decreases the result for the seating plan.

5. The method of claim 1, wherein:
the result for the seating plan is determined by adding scores for criteria that are satisfied by the seating plan from the result and subtracting scores for criteria that are not satisfied by the seating plan from the result, and
the scores are determined based on a priority value associated with the criteria.

6. The method of claim 1, wherein:
the valuation function values a first criterion in the set of criteria based on a first type of priority value, and
the valuation function values a second criterion in the set of criteria based on a second type of priority value.

7. The method of claim 6, wherein:
the first type of priority value comprises a numeric scale, and
the second type of priority value indicates the criterion needs to be met in the seating plan.

8. The method of claim 7, wherein:
a first score for the first type of priority value is based on the number in the numeric scale, and
a second score for the second type of priority value is above a highest number in the numeric scale.

9. The method of claim 1, wherein receiving the input specifying the criteria comprises:
receiving first input from a first type of user; and
receiving second input from a second type of user, wherein the first type of user has different rights to input different information for criteria from the second type of user.

10. The method of claim 9, wherein the first type of user can input the priority value and the second type of user cannot input the priority value.

11. The method of claim 1, further comprising:
receiving a request to input the criteria from a user;
determining a role of the user in a company;
when the user is associated with a first type of role, outputting a first type of interface allowing the user to input a first type of criteria; and
when the user is associated with a second type of role, outputting a second type of interface allowing the user to input a second type of criteria.

12. The method of claim 11, wherein the first type of criteria allows an input for the priority value and the second type of criteria does not allow an input for the priority value.

13. The method of claim 11, wherein:
the first type of criteria allows the user to input criteria that apply the user to other users or objects and also criteria that apply other users to the user or other users or objects, and
the second type of criteria allows the user to only input criteria that apply the user to other users or objects.

14. The method of claim 11, wherein:
when the user is associated with the first type of role, the first type of interface allows the user to see criteria input by other users, and
when the user is associated with the second type of role, the second type of interface does not allow the user to see criteria input by other users.

15. The method of claim 1, wherein creating the set of seating plans comprises:
generating seating plans that include different combinations of users placed in locations in the layout based on the priority values assigned to the criteria, wherein not all possible combinations of seating plans are generated.

16. The method of claim 1, wherein creating the set of seating plans comprises:
analyzing the priority values assigned to the criteria to generate a subset of possible combinations of users in the layout;
identifying a criterion in the criteria with a priority value that when not fulfilled would result in a score lower than scores in the subset of possible combinations; and
not generating the seating plan for combinations that do not meet the criterion.

17. A non-transitory computer-readable storage medium containing instructions, that when executed, control a computer system to be configured for:
receiving input specifying criteria for generating a seating plan, wherein at least a portion of the criteria includes a priority value;
receiving a layout of locations in which the seating plan is applied;
receiving a valuation function that defines a scoring system for the plan, the scoring system using the priority value to generate a score for criteria associated with the priority value;
creating a set of seating plans based on the criteria to place users in locations in the layout, wherein the set of seating plans include different combinations of users placed in different locations;
selecting a seating plan that maximizes a result from scores generated for criteria in the seating plan over other results associated with other seating plans; and
outputting the seating plan.

18. The non-transitory computer-readable storage medium of claim 17, wherein selecting the seating plan comprises:
evaluating a criterion in the criteria based on a seating plan in the set of seating plans;
generating a score for the criterion based on the valuation function and the evaluating.

19. The non-transitory computer-readable storage medium of claim 17, wherein:
the result for the seating plan is determined by adding scores for criteria that are satisfied by the seating plan from the result and subtracting scores for criteria that are not satisfied by the seating plan from the result, and
the scores are determined based on a priority value associated with the criteria.

20. An apparatus comprising:
one or more computer processors; and
a non-transitory computer-readable storage medium comprising instructions, that when executed, control the one or more computer processors to be configured for:
receiving input specifying criteria for generating a seating plan, wherein at least a portion of the criteria includes a priority value;
receiving a layout of locations in which the seating plan is applied;
receiving a valuation function that defines a scoring system for the plan, the scoring system using the priority value to generate a score for criteria associated with the priority value;
creating a set of seating plans based on the criteria to place users in locations in the layout, wherein the set of seating plans include different combinations of users placed in different locations;
selecting a seating plan that maximizes a result from scores generated for criteria in the seating plan over other results associated with other seating plans; and
outputting the seating plan.
